(19) United States
(12) Patent Application Publication
(10) Pub. No.: US 2008/0144516 A1
(43) Pub. Date: Jun. 19, 2008

(54) Control circuit for detecting loop state

(75) Inventor: Ren-Horng You, Shanhua Township (TW)

Correspondence Address: RABIN & Berdo, PC, 1101 14TH STREET, NW, SUITE 500, WASHINGTON, DC, 20005, US

(73) Assignee: INSTITUTE FOR INFORMATION INDUSTRY, Taipei City (TW)

(21) Appl. No.: 11/808,799

(22) Filed: Jun. 13, 2007

(30) Foreign Application Priority Data
Dec. 13, 2006 (TW) 095146764

(51) Int. Cl. G08C 15/00

(52) U.S. Cl. 370/249

(57) ABSTRACT

A control circuit for detecting a loop state includes a signal indication module, a three-way switch, a remote control module, and a detection module. The three-way switch and the remote control module are connected in series between the load and a power source. When the three-way switch is pressed down or the remote control module receives a wireless signal sent from the signal indication module, the remote control module or the three-way switch is switched to form a closed/open circuit state between the power source and the load. The detection module connects the load and the remote control module, and detects an actuation state of the remote control module and the load when receiving the wireless signal, so as to generate determination information and state information, and display the information, such that a user can know whether the load loop runs normally.

This non-provisional application claims priority under 35 U.S.C. §119(a) on Patent Application No(s). 095146764 filed in Taiwan, R.O.C. on Dec. 13, 2006, the entire contents of which are hereby incorporated by reference.

### BACKGROUND OF THE INVENTION

1. Field of Invention

The present invention relates to a control circuit, and more particularly, to a control circuit for detecting the state of a load loop.

2. Related Art

Referring to FIG. 1, a schematic view of the circuit structure of a conventional manipulation circuit is shown. The manipulation circuit 100 includes a remote control device 110, a switch device 120, a load 101, and a power source 102.

The remote control device includes a control module 111 and a switching module 112, and a storage unit 113 is disposed in the control module 111. The control module 111, the switch device 120, and the power source 102 are connected in series to form a switch loop, and the control module 111, the switching module 112, and the load 101 are also connected in series to form a load loop.

When the switch device 120 is actuated, the voltage of the switch loop is changed. When detecting the voltage change of the switch loop, the control module 111 controls the switching module 112 to switch the load loop between the closed or open state, such that the load 101 is connected with the power source 102 and then is started, or disconnected from the power source 102 and then is stopped.

The storage unit 113 is used to store the closed/open circuit information of the load loop. When the control module 111 does not detect the voltage change of the switch loop, but receives a wireless signal, the control module 111 will actuate the switching module 112 according to the closed/open circuit information of the load loop stored in the storage unit 113, such that the load loop forms a closed circuit or an open circuit, and the latest closed/open circuit information of the load loop is stored in the storage unit 113.

However, the conventional manipulation circuit still has an inevitable defect, i.e., the control module 111 stores the closed/open circuit information in the storage unit 113 only when the wireless signal is received. When a user performs manual control through the switch device 120, the control module 111 will not update the closed/open circuit information stored in the storage unit 113. If the user frequently switches between the remote control and the manual control modes alternately, the control module 111 easily stores incorrect close/open circuit information. Thus, when the wireless signal is received, the control module 111 makes the switching module 112 to be switched incorrectly according to the incorrect close/open circuit information, thereby damaging the entire remote control device 110.

Furthermore, the control module 111 simply determines the state of the load 101 according to the closed/open state of the load loop only when receiving the wireless signal, but cannot determine whether the load 101 is damaged definitely.

### SUMMARY OF THE INVENTION

In view of the above, in order to solve the aforementioned problems, the present invention provides a control circuit for detecting a loop state, which is directed to providing a remote control module and a manual control module in the control circuit to control a load to be turned on and turned off, determining whether the remote control module and the load are damaged through detecting actuation states of the remote control module and the load, and then displaying determination results and the actuation states of the remote control module and the load, such that a user can know whether the remote control module and the load run normally.

The present invention provides a control circuit for detecting a loop state. The control circuit is disposed in a load loop, and detects the actuation state of the load loop. The load loop includes a power source and a load, and the control circuit includes a signal indication module, a three-way switch, a remote control module, and a detection module.

The signal indication module sends a wireless signal to the remote control module and the detection module.

The three-way switch and the remote control module are connected in series between the power source and the load, and the three-way switch is electrically connected to the remote control module. When the three-way switch is actuated, a closed/open circuit is formed between the three-way switch and the remote control module, such that the load loop is turned on and the load is connected with the power source, or the load loop is turned off and the load is disconnected from the power source.

When receiving the wireless signal, the remote control module is actuated to form the closed/open circuit, such that the load loop is turned on and the load is connected with the power source, and the load loop is turned off and the load is disconnected from the power source.

The detection module is electrically connected to the load and the remote control module, and detects whether the remote control module is actuated when receiving the wireless signal, so as to generate a determination information. Meanwhile, the detection module detects the actuation state of the load to generate a state information. Furthermore, the detection module further includes a display unit on which the determination information and the state information are displayed.

The detection module further includes a wireless echo unit, and the signal indication module further includes an echo receiving unit and an echo display unit. The detection module transmits the state information and the determination information to the echo receiving unit wirelessly through the wireless echo unit, and the signal indication module displays the state information and the determination information through the echo display unit.

The control circuit provided by the present invention further includes a recording module, which is electrically connected to the detection module. When the detection module generates the determination information or the state information, the determination information or the state information is stored in the recording module.

The control circuit provided by the present invention further includes a connection port, which is electrically connected to the recording module, and through which an external display device is electrically connected to the recording module. The external display device obtains the state information and the determination information and displays them thereon. The external display device is a TV, a display screen, or a notebook computer, and is connected to the connection port in a wired mode.

In the control circuit provided by the present invention, the remote control module includes a signal processing unit and a switching unit. The switching unit is connected in series between the power source and the load, and is electrically connected to the three-way switch. The signal processing unit receives the wireless signal to control switching of the switching unit, so as to turn on/off the load loop.

In the control circuit provided by the present invention, the detection module further includes a power source detection unit. The power source detection unit detects a changing state of a voltage/current of the load, so as to detect whether the load is started or stopped.

Furthermore, the control circuit prevents the remote control module from performing incorrect switching by adjusting the interaction between the detection module and the remote control module. That is to say, when the detection module receives the wireless signal, whether the load is turned on or turned off is firstly detected, and the load information is transmitted to the remote control module, and then the remote control module is instructed to perform the state switching according to the load information when receiving the wireless signal.

The present invention has the efficacies that cannot be achieved by the prior art. According to the determination information and the state information displayed in sync, the user can determine whether the load and the remote control module run normally. The determination information represents whether the remote control module is actuated, such that the user can know whether the remote control module is damaged. If the remote control module runs normally, after the remote control module is switched twice, the user can know whether the load is abnormal according to whether the state information changes or not. Furthermore, a circuit designer can add such circumstance determinations in the control program of a detection module, so as to enable the detection module to directly display which one is in an abnormal state when the load or the remote control module runs abnormally. Furthermore, by adjusting the interaction between the detection module and the remote control module, the damage of the remote control module caused by incorrect state switching of the remote control module is prevented.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view of the circuit structure of the manipulation circuit in the prior art;

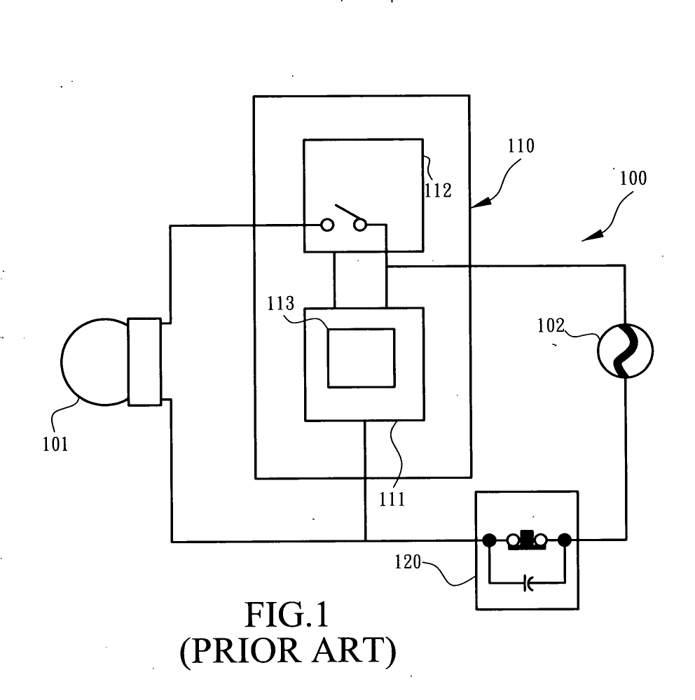

FIG. 2 is a schematic view of the circuit structure of the first embodiment of the present invention;

FIG. 3 is a schematic view of the circuit structure of the second embodiment of the present invention;

FIG. 4 is a schematic view of the circuit structure of the third embodiment of the present invention; and

FIG. 5 is a schematic view of the circuit structure of the fourth embodiment of the present invention.

### DETAILED DESCRIPTION OF THE INVENTION

In order to further understand the objectives, the constitutive features, and the functions of the present invention, the present invention will be illustrated in detail below with reference to the relevant embodiments and the accompanying drawings.

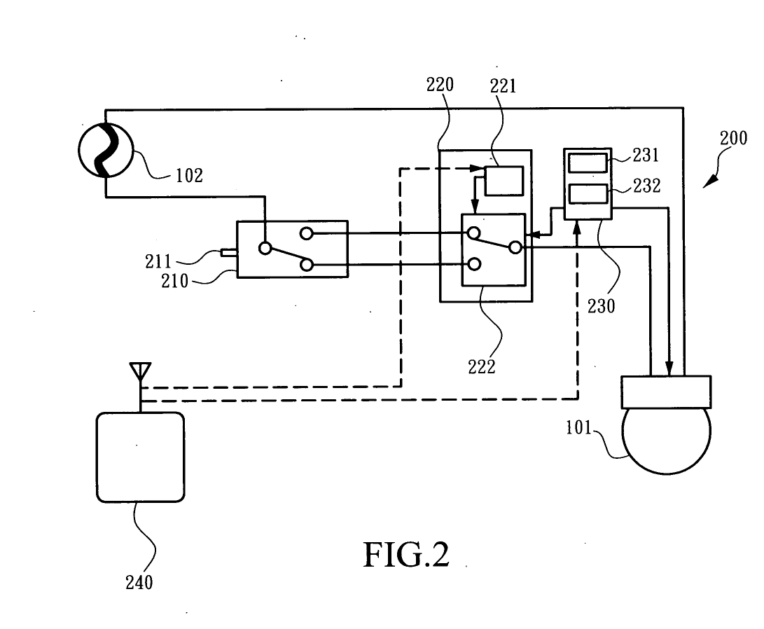

Referring to FIG. 2, a schematic circuit diagram of the first embodiment of the present invention, i.e., a schematic view of the basic circuit structure of a control circuit 200 is shown. The control circuit 200 includes a load 101, a power source 102, a three-way switch 210, a remote control module 220, a detection module 230, and a signal indication module 240.

In this embodiment, the remote control module 220 includes a switching unit 222 and a signal processing unit 221. The three-way switch 210 is electrically connected to the switching unit 222, so as to establish two different electric power transmission paths. The three-way switch 210 is further electrically connected to the power source 102, so as to transmit electric power provided by the power source 102. The switching unit 222 is electrically connected to the load 101 and the three-way switch 210. The power source 102, the three-way switch 210, the switching unit 222, and the load 101 are connected in series to form a series circuit.

The signal indication module 240 sends a wireless signal, and the signal processing unit 221 is electrically connected to the switching unit 222 and receives the wireless signal. The detection module 230 is electrically connected to the load 101 and the remote control module 220, so as to receive the wireless signal. The detection module 230 comprises a display unit 231.

Under the circumstance of remote control, a user uses the signal indication module 240 to send a wireless signal, which is then received by the signal processing unit 221 and the detection module 230. The signal processing unit 221 actuates the switching unit 222 after receiving the wireless signal. The switching unit 222 switches between the two different electric power transmission paths, so as to change the transmission path of the electric power, such that the switching unit 222 and the three-way switch 210 are switched between the ON state and the OFF state.

The detection module 230 detects the actuation of the switching unit 222 when receiving the wireless signal, and determines whether the remote control module 220 runs normally according to whether the switching unit 222 is actuated, thereby generating a determination information. Furthermore, the detection module 230 detects the actuation state of the load 101, and generates a state information. Finally, the detection module 230 displays the determination information and the state information with the display unit 231, and the detection module 230 knows whether the remote control module 220 and the load 101 are damaged or not according to the determination information and the state information.

When the detection module 230 detects that the switching unit 222 is actuated abnormally or has not been actuated, the remote control module 220 must be damaged. On the contrary, if the switching unit 222 switches the electric power transmission paths normally, it is represented that the signal processing unit 221 is actuated normally. Therefore, the detection module 230 determines that the remote control module runs normally.

When the remote control module 220 is actuated normally, if a user sends two wireless signals through the signal indication module 240, the remote control module 220 is switched twice. If the detection module 230 detects that the load 101 is switched twice between the ON state and the OFF state, it is represented that the load 101 runs normally. On the contrary, if the actuation state of the load 101 often or always cannot be switched, it is represented that the load 101 is in an error state.

Generally speaking, the most common method of detecting the actuation state of the load 101 is to detect the actuation voltage or the actuation current of the load 101. Therefore, a power source detection unit 232 is disposed on the detection module 230, which is used to detect the voltage/current of the load 101 continuously, and the detection module 230 determines the actuation state of the load 101 according to the change of the values of the voltage/current, so as to generate the state information.

The three-way switch 210 further has a switching key 211. Under the circumstance of manual control, the user presses the switching key 211 to make the three-way switch 210 be switched between the two electric power transmission paths, so as to change the transmission path of the electric power, such that the three-way switch 210 and the switching unit 222 are switched between the ON state and the OFF state. Thus, the load loop 200 is turned on, and the load 101 is connected with the power source 102 and is actuated; or the load loop 200 is turned off, and the load 101 is disconnected from the power source 102 and is not actuated. The power source detection unit 232 detects the voltage/current change of the load 101, and the detection module 230 determines the actuation state of the load 101 according to the change of the values of the voltage/current, so as to generate the state information and display it on the display unit 231.

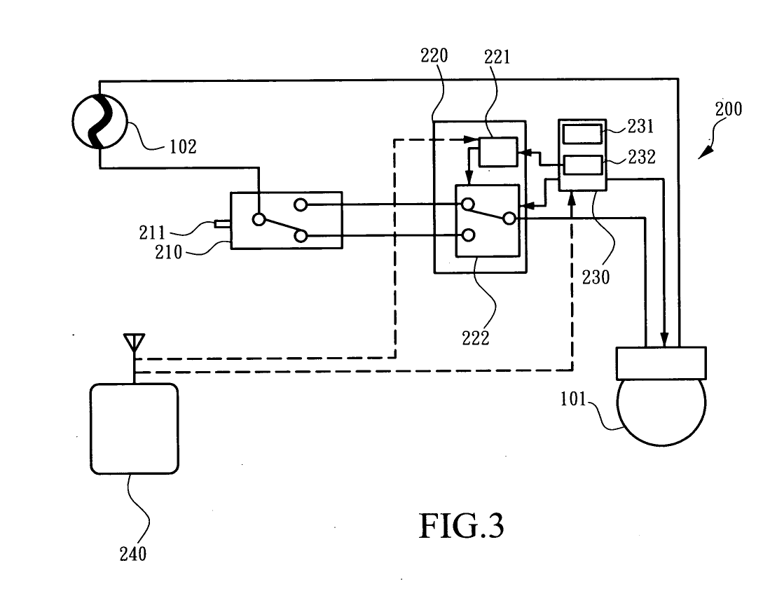

Referring to FIG. 3, a schematic view of the circuit structure of the second embodiment of the present invention is shown. The second embodiment is different from the first embodiment in the following aspects. The detection module 230 firstly detects the current state of the load 101 when receiving the wireless signal and generates a load information, which is outputted to the signal processing unit 221. The signal processing unit 221 firstly obtains the load information when receiving the wireless signal, and actuates the switching unit 222 according to the load information. The power source detection unit 232 detects the current voltage/current of the load 101, and the detection module 230 determines the current state of the load 101 according to the voltage/current value, so as to generate the load information.

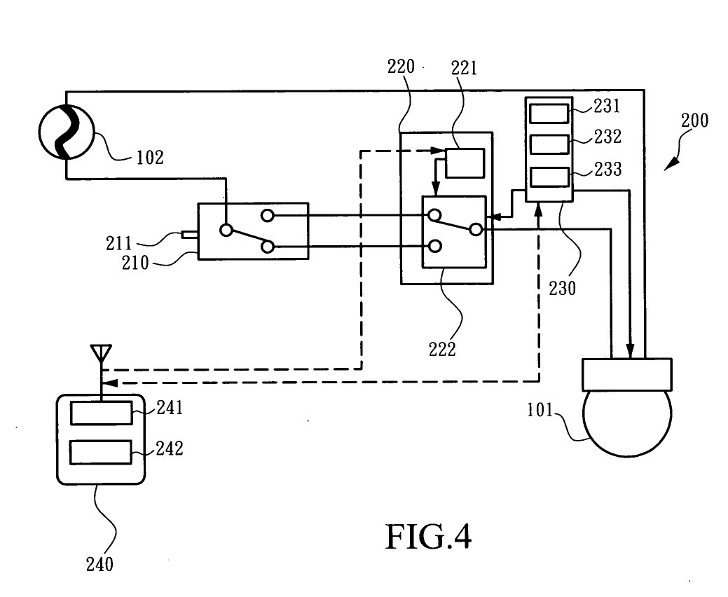

Referring to FIG. 4, a schematic view of the circuit structure of the third embodiment of the present invention is shown. The third embodiment is different from the first embodiment in the following aspects. The detection module 230 has a wireless echo unit 233, and the signal indication module 240 has an echo receiving unit 241 and an echo display unit 242. When the detection module 230 generates the determination information or the state information, the determination information or the state information is transmitted to the echo receiving unit 241 wirelessly through the wireless echo unit 233. The signal indication module 240 displays the determination information or the state information using the echo display unit 242.

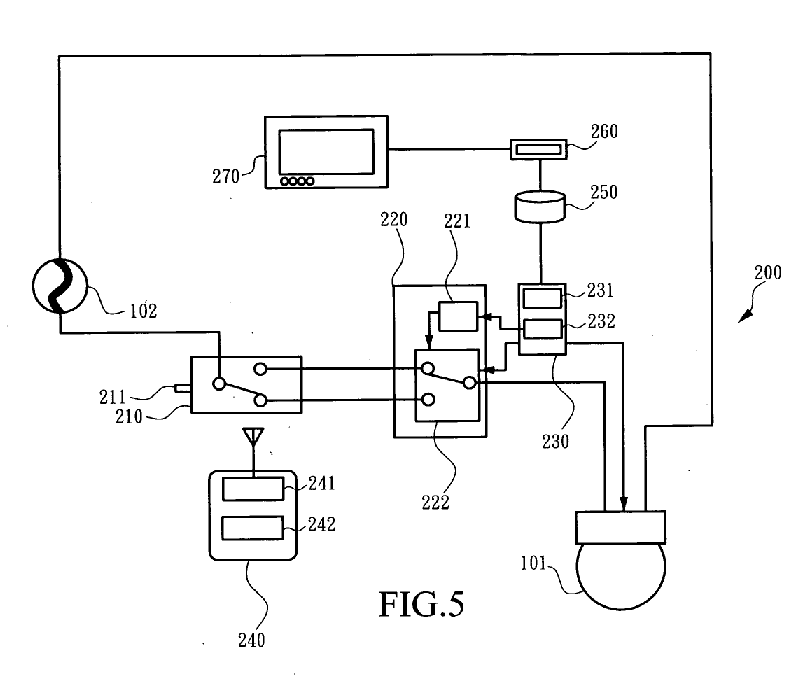

Referring to FIG. 5, a schematic view of the circuit structure of the fourth embodiment of the present invention is shown. The fourth embodiment is different from the first embodiment in the following aspects. The control circuit 200 further includes a connection port 250 and a recording module 260. The recording module 250 is electrically connected to the detection module 230. After the detection module generates the determination information/the state information, the determination information/the state information is stored in the recording module 250. The connection port 260 is further electrically connected to the recording module 250, and the connection port 260 provides electrical connection with an external display device 270. The external display device 270 is electrically connected to the recording module 250 through the connection port 260, so as to obtain the determination information and the state information stored in the recording module 250, and to display the determination information and the state information on the external display device 270.

In view of the above, the control circuit 200 prevents the remote control module 220 from incorrect state switching. Moreover, the control circuit 200 utilizes the detection module 230 to detect the actuation states of the remote control module 220 and the load 101, and then displays such information on the display unit 231, or outputs such information wirelessly and displays it on the signal indication module 240. Such information is further stored in the recording module 250, and the connection port 260 is provided for electrically connecting the external display device 270, such that the external display device 270 can obtain the information stored in the recording module 250 and display it. Therefore, the user can know the operation state of the load 101 any moment and anywhere, and control the actuation of the load 101 manually or remotely.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A control circuit for detecting a loop state, disposed in a load loop, for detecting an actuation state of the load loop, wherein the load loop comprises a power source and a load, the control circuit comprising:
a signal indication module, sending a wireless signal;
a three-way switch, connected in series between the power source and the load;
a remote control module, connected in series between the power source and the load and electrically connected to the three-way switch, wherein when receiving the wireless signal, the remote control module is selectively actuated to form a closed/open circuit with the three-way switch, such that the load loop is turned on and the load is connected with the power source, or the load loop is turned off and the load is disconnected from the power source; and
a detection module, electrically connected to the load and the remote control module, wherein the detection module comprises a display unit, and detects whether the remote control module is actuated when receiving the wireless signal, so as to generate a determination information, and meanwhile, the detection module detects the actuation state of the load and generates a state information, and the determination information and the state information are displayed on the display unit.

2. The control circuit as claimed in claim 1, wherein the detection module further comprises a wireless echo unit, and the signal indication module further comprises an echo receiving unit and an echo display unit, the detection module transmits the state information and the determination information to the echo receiving unit wirelessly through the wireless echo unit, and displays the state information and the determination information on the echo display unit.

3. The control circuit as claimed in claim 1, further comprising a recording module electrically connected to the detection module, wherein after the detection module generates the determination information, the determination information is stored in the recording module, and after the detection module generates the state information, the state information is stored in the recording module.

4. The control circuit as claimed in claim 3, further comprising a connection port electrically connected to the recording module, wherein an external display device is electrically connected to the recording module through the connection port, and the external display device obtains the state information and the determination information and displays the state information and the determination information on the external display device.

5. The control circuit as claimed in claim 4, wherein the external display device is a TV, a display screen, or a notebook computer, and is connected to the connection port in a wired mode.

6. The control circuit as claimed in claim 1, wherein the remote control module comprises a signal processing unit and a switching unit, the switching unit is connected in series between the power source and the load and is electrically connected to the three-way switch, the signal processing unit receives the wireless signal to actuate the switching unit, such that the load loop is turned on and the load is connected with the power source, or the load loop is turned off and the load is disconnected from the power source.

7. The control circuit as claimed in claim 6, wherein when the detection module receives the wireless signal, the detection module firstly detects a state of the load to generate a load information and outputs the load information to the signal processing unit, and when the signal processing unit receives the wireless signal, the signal processing unit firstly obtains the load information and actuates the switching unit according to the load information.

8. The control circuit as claimed in claim 1, wherein when the three-way switch is actuated, the three-way switch forms the closed/open circuit with the remote control unit, such that the load loop is turned on and the load is connected with the power source, or the load loop is turned off and the load is disconnected from the power source.

9. The control circuit as claimed in claim 8, wherein the detection module further comprises a power source detection unit, for detecting a change of a voltage/current of the load to determine the actuation state of the load.
